(19) United States
(12) Patent Application Publication
(10) Pub. No.: US 2012/0015788 A1
(43) Pub. Date: Jan. 19, 2012

(54) MACHINE AND METHOD FOR MAKING COMPOSITE FILTERS

(75) Inventors: Marco RIGHETTI, Casalecchio di Reno (Bologna) (IT); Giampaolo GIANESE, San Pietro in Casale (Bologna) (IT); Massimo SARTONI, Bologna (IT)

(73) Assignee: G.D S.p.A, Bologna (IT)

(21) Appl. No.: 13/172,438

(22) Filed: Jun. 29, 2011

(30) Foreign Application Priority Data
Jul. 15, 2010 (IT) BO2010A000453

(51) Int. Cl. B31C 99/00

(52) U.S. Cl. 493/47

(57) ABSTRACT

A machine (100) for making composite filters (FA, FB), that is, filters consisting of at least two filter segments (S1, S2, S3, S4), comprises: a plurality of feed lines (L1, L2, L3, L4) supplying filter plugs (S1, S2, S3, S4; S1A, S1B, S2A, S2B) made of different materials and/or having different filtration properties; a conveying system (6) by which the plugs (S1, S2, S3, S4; S1A, S1B, S2A, S2B) are combined in such a way as to form and release a first succession and a second succession of filter groups (GA, GB) made of different materials and/or having different filtration properties, alternated one with another, each group (GA, GB) comprising a predetermined combination of filter plugs (S1, S2, S3, S4; S1A, S1B, S2A, S2B); a garniture tongue (2) with two channels (CA, CB) along which a first filter rod (BA) and a second filter rod (BB) are formed, the first rod (BA) and the second rod (BB) respectively comprising the first succession and the second succession of filter groups (GA, GB); cutting means (3) by which the two filter rods (BA, BB) are divided up to produce two respective successions of composite filters (FA, FB) differing one from another.

This application claims priority to Italian Patent Application BO2010A000453 filed Jul. 15, 2010, the entirety of which is incorporated by reference herein.

### BACKGROUND OF THE INVENTION

This invention relates to a machine and method for making composite filters.

The term “composite filter” means a cigarette filter obtained by joining end-to-end two or more filter segments made of different materials and/or having different filtration properties.

Assembling machines are known which comprise a first feed line supplied with a first stick of filter material and equipped with respective cutting means for dividing up the first stick to form first filter plugs, and at least a second feed line which is substantially the same as the first feed line and supplied with a second stick of filter material which is divided up to form second filter plugs.

The first and at least second filter plugs are conveyed along the feed lines transversely to their longitudinal axes by means of rotating conveyors towards a single assembling conveyor consisting of a plurality of counter-rotating rollers designed to combine the first plugs with the at least second filter plugs.

The assembling conveyor is configured in such a way that the last roller conveys into each flute a first and at least second filter plug combined to form a filter group.

Each filter group consists of as many filter plugs as there are feed lines and all the filter groups are identical to each other.

Downstream of the assembling conveyor, the assembling machine comprises a transfer unit by which the filter plugs are supplied to a garniture tongue.

The transfer unit comprises rotating rollers configured to divide the flow of filter groups between two distinct feed paths and a rotating member designed to take up pairs of filter groups conveyed respectively along the two feed paths and to transfer them in such a way that they are parallel to their longitudinal axes.

The garniture tongue comprises two channels or lines, each respectively supplied by one of the two filter groups released by the rotating member of the transfer unit.

The garniture tongue also has a garniture station which is designed to wrap the filter groups in a strip of paper to form two continuous filter rods.

Downstream of the garniture tongue there is a single cutting station comprising a cutting means which simultaneously cuts both filter rods to make the composite filters.

A need strongly felt by cigarette manufacturers, that is, by users of the assembling machines, is that for versatile machines and systems making it possible to produce different types of filters with high economies of production.

### SUMMARY OF THE INVENTION

The aim of this invention is to satisfy the above mentioned need.

According to the invention this aim is achieved in a machine and a method for making composite filters whose features are as recited in one or more of the annexed claims.

### BRIEF DESCRIPTION OF THE DRAWINGS

The technical features of the invention, with reference to the above aim, are clearly described in the claims below and its advantages are apparent from the detailed description which follows, with reference to the accompanying drawings which illustrate a preferred, non-limiting example embodiment of the invention, and in which:

FIG. 1 is a schematic side view of a preferred embodiment of the machine for making composite filters according to this invention;

FIGS. 2 to 6 are schematic side views showing scaled-up details of the machine according to the invention, illustrated in FIG. 1;

FIG. 7 illustrates in a scaled-up schematic plan view the filter rods made by the machine of FIG. 1;

FIG. 8 illustrates a further embodiment of the machine for making composite filters according to this invention;

FIG. 9 illustrates in a scaled-up schematic plan view the filter rods made by the machine of FIG. 8;

FIGS. 10A, 10B, 10C, 10D show scaled-up details of FIGS. 2, 3, 4 and 5, respectively.

### DESCRIPTION OF THE PREFERRED EMBODIMENTS

With reference to the accompanying drawings, the numeral 100 denotes a machine for making filters of different materials and/or having different filtration properties, made up of at least two filter plugs S1, S2, S3, S4.

The term “filter plug” as used in this description means a piece S1, S2, S3, S4 of substantially uniform filter material, obtained preferably by cutting a stick of filter material (that is to say, a plug is a portion of the stick of filter material).

The term “filter group” as used herein means a group (or set) of filter plugs S1, S2, S3, S4 of different types, that is to say, made of different materials and/or having different filtration properties, lined up longitudinally with each other.

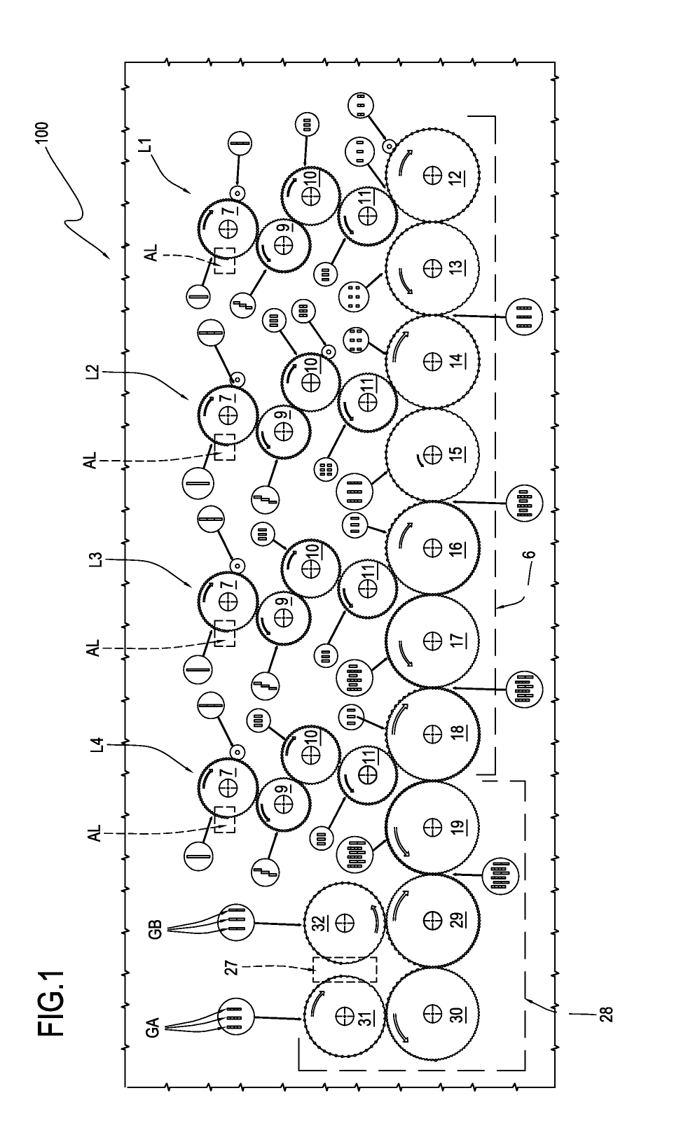

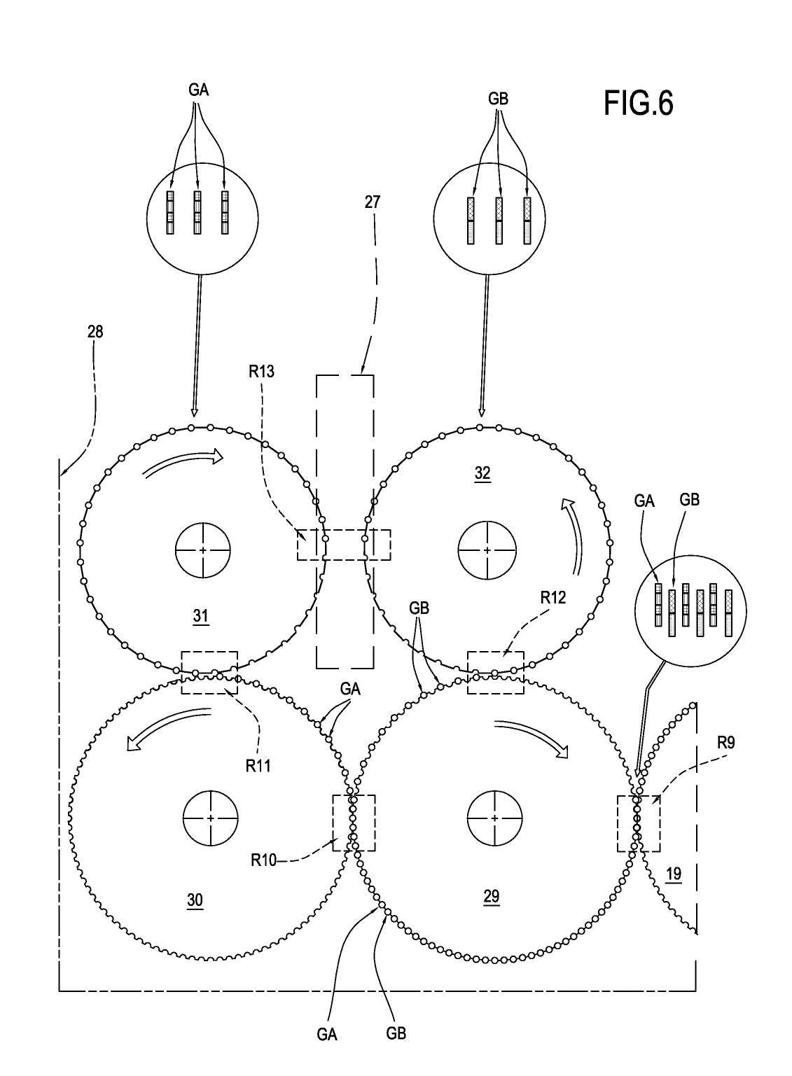

In a preferred embodiment illustrated in FIGS. 1 to 6, the machine 100 comprises a plurality of feed lines L1, L2, L3, L4 supplying filter plugs S1, S2, S3, S4 made of different materials and/or having different filtration properties.

More specifically, in the example shown in FIG. 1, the machine 100 comprises a feed line L1, a second L2, a third L3 and a fourth L4, denoted individually by L1, L2, L3 and L4.

Each feed line L1, L2, L3 and L4 is designed to supply a respective filter plug S1, S2, S3, S4 made of a predetermined material and/or having a predetermined filtration property. The four feed lines L1, L2, L3 and L4 preferably supply filter plugs S1, S2, S3, S4 made of different types of material.

The detailed description which follows refers to the first line L1 only, while the other feed lines L2, L3, and L4 are described only in the aspects of them that differ from the first line.

It should also be noted that for clarity of reference to the component parts of the second, third and fourth lines L2, L3 and L4 having the same technical and functional features as the first line L1, the same reference characters as those used to indicate the first line L1 are used.

Also, in FIGS. 1 to 6, beside each component or part illustrated there is a circular label showing a plan view of the arrangement of the filter sticks/plugs/groups, with an arrow indicating the component that arrangement refers to.

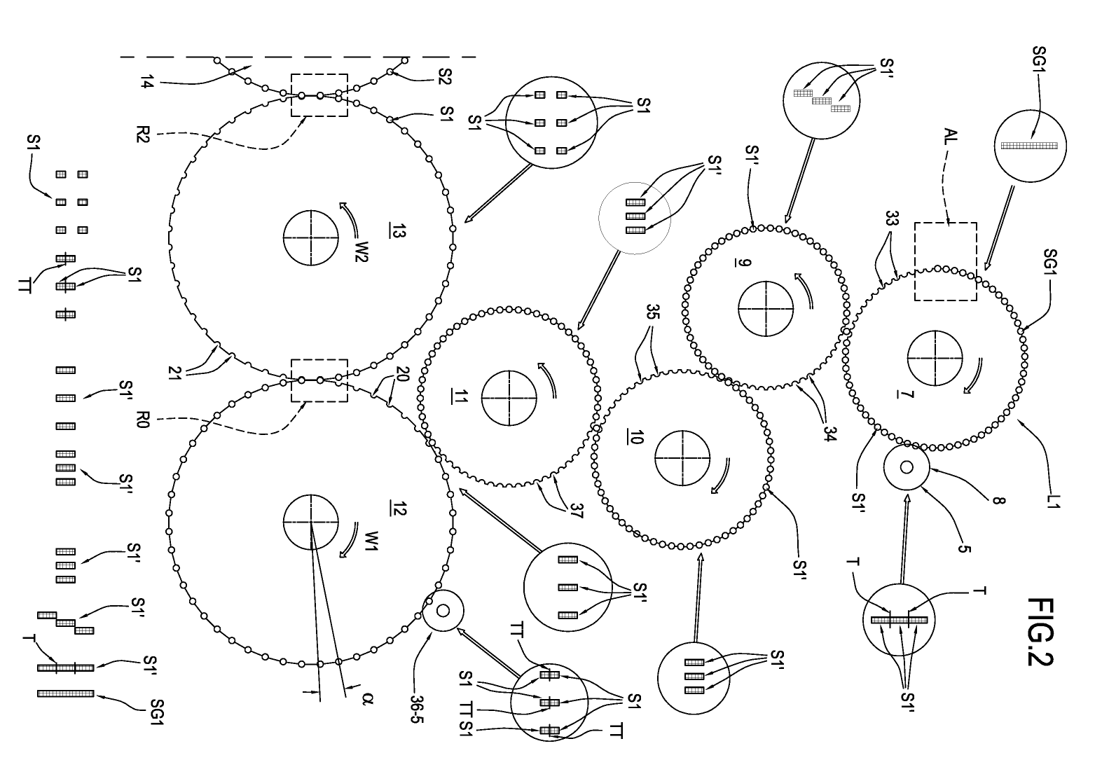

With reference to the drawings illustrating the preferred embodiment of the machine 100, it should be noted that FIG. 1 shows an assembly view of the machine 100, while FIGS. 2 to 5 are scaled-up views showing the first, second, third and fourth feed lines L1, L2, L3 and L4, respectively.

The first feed line L1 comprises a feed hopper (illustrated schematically and labeled AL) for supplying first sticks SG1 of filter material.

In this regard, it should be noted that the following terms are used in this description:

“first sticks” means the sticks SG1 of filter material supplied to the first feed line L1;

“second sticks” means the sticks SG2 of filter material supplied to the second feed line L2;

“third sticks” means the sticks SG3 of filter material supplied to the third feed line L3;

“fourth sticks” means the sticks SG4 of filter material supplied to the fourth feed line L4.

The sticks SG1, SG2, SG3, SG4 of filter material are basically bars of filter material extending longitudinally.

Preferably, the filter sticks SG1, SG2, SG3, SG4 are substantially cylindrical in shape.

The first feed line L1 comprises a pick-up roller 7 connected to the feed hopper AL to take up the first sticks SG1 of filter material.

The pick-up roller 7 is furnished with elongate peripheral flutes 33 running parallel to the rotational axis of the roller 7.

The flutes 33 accommodate the successions of first sticks SG1 of filter material, that is to say, each flute 33 is designed to receive a first stick SG1 of filter material.

The flutes 33 are preferably of the suction type, which easily hold the filter sticks SG1.

The first feed line L1 further comprises a first cutting means 8 designed to sever the filter sticks transversely along at least one transverse cutting line T to make filter plugs S1′.

Preferably, the first cutting means 8 is associated with the pick-up roller 7 and is designed to divide the filter sticks SG1.

The first cutting means 8 constitutes means 5 by which the respective filter sticks SG1 are severed.

For example, as illustrated in FIG. 2 purely by way of an example, the first cutting means 8 divides the filter sticks into three plugs S1′ of equal length.

The first feed line L1 also comprises an intercalating roller 9 (configured to take out of alignment the plugs S1′) acting in conjunction with the pick-up roller 7.

The intercalating roller 9 is furnished with elongate peripheral flutes 34 running parallel to its rotational axis.

In a known manner not described in detail here, the intercalating roller 9 receives the plugs S1′ from the pick-up roller 7 and moves them angularly in offset arrangement one relative to the one adjacent to it in such a way that the plugs S1′ are parallel and stepped relative to each other.

Downstream of the intercalating roller 9 there is a centering roller 10 which, in known manner, receives the plugs S1′ in respective peripheral grooves 35, or peripheral flutes 35 and moves the plugs S1′ axially along the flutes 35 in such a way to align them in the transverse feed direction.

After aligning them, the centering roller 10 releases the first plugs S1′ to a transfer roller 11 which acts in conjunction with the centering roller 10.

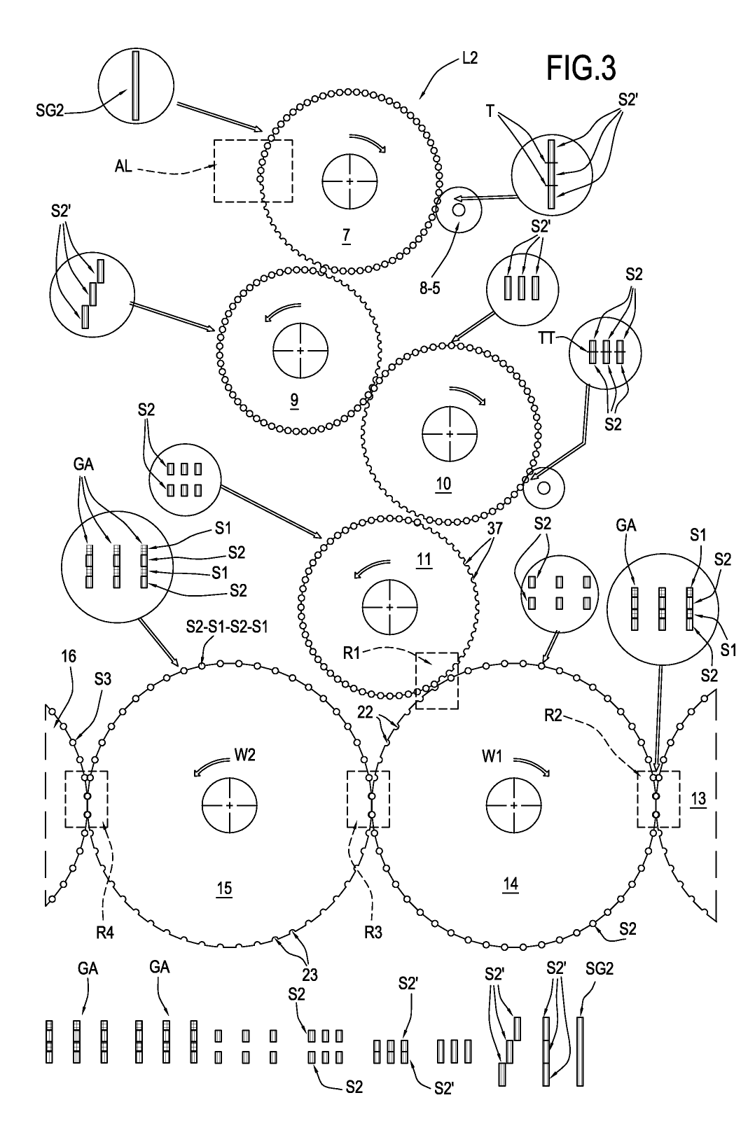

The second feed line L2, shown in more detail in FIG. 3 is substantially the same as the first feed line L1 described above.

It should be noted that the second feed line L2 differs from the first feed line L1 in that at the centering roller 10 there is a second cutting means 36 for further severing the plugs S2′ along at least a further transverse cutting line TT as they advance on the centering roller 10.

Also in known manner not described here, the second plugs S2′ present in each flute 37 of the transfer roller 11 are spaced from each other longitudinally, as illustrated in FIG. 3 in the circle associated with the transfer roller 11.

The third and fourth feed lines L3 and L4 differ from the first feed line L1 in that they do not have the second cutting means 36 and thus the respective plugs are not divided further after being severed by the first cutting means 8 downstream of the pick-up roller 7.

It should be noted that in all the feed lines L1, L2, L3, L4, the respective filter plugs S1, S2, S3, S4 are transferred transversely to their longitudinal axes.

According to the invention, the machine 100 comprises a conveying system 6 by which the plugs S1, S2, S3, S4 supplied by the feed lines L1, L2, L3, L4 are combined and which is designed to receive the plugs S1′, S2, S3, S4 from the transfer rollers 11 of the feed lines L1, L2, L3, L4.

In the description below, the following terms will be used with reference to the preferred embodiment of FIGS. 1 to 6:

“first plugs” to denote the filter plugs made from the first sticks SG1 of filter material;

“second plugs” to denote the filter plugs made from the second sticks SG2 of filter material;

“third plugs” to denote the filter plugs made from the third sticks SG3 of filter material;

“fourth plugs” to denote the filter plugs made from the fourth sticks SG4 of filter material.

The conveying and combining system 6 comprises a plurality of rollers 12-18 acting in conjunction with each other.

Each of the rollers 12-18 of the conveying and combining system 6 is furnished with respective peripheral flutes 20, 21, 22, 23, 24, 25, 26 running parallel to its rotational axis and designed to accommodate the filter plugs S1, S2, S3, and S4 as described in more detail below.

Preferably, the flutes 20, 21, 22, 23, 24, 25, 26 of the rollers 12-18 of the conveying and combining system 6 are also suction type flutes, that is to say, they are connected to suction means which can be activated to hold each of the filter plugs S1, S2, S3, and S4 down in its flute by a negative pressure force.

Still more preferably, the rollers 12-18 of the conveying and combining system 6 are the same in size.

With reference to the embodiment illustrated in FIGS. 1 to 6, the conveying and combining system 6 comprises seven rollers 12-18 which, for clarity, are individually denoted by the reference numerals 12 to 18.

It should be noted that the rollers 12-18 of the conveying and combining system 6 form a conveying path along which the plugs S1, S2, S3, S4 released by the four feed lines L1, L2, L3, L4 are directed to a transfer unit 28 downstream, described in more detail below.

The conveying and combining system 6 is adapted to form and release two successions of filter groups GA, GB made of different materials and/or having different filtration properties, that is to say, it is adapted to combine with each other the filter plugs S1, S2, S3, S4 made from the filter sticks SG1, SG2, SG3, SG4.

For clarity, the filter groups GA, GB are denoted individually as first filter group GA and second filter group GB.

Each filter group GA, GB consists of a predetermined combination of filter plugs S1, S2, S3, S4.

By way of a non-limiting example, in the preferred embodiment illustrated in FIGS. 1 to 6, the two filter groups GA, GB comprise filter plugs supplied by different feed lines, that is to say, the first filter group GA composed of first plugs S1 and second plugs S2 supplied by the first feed line L1 and by the second feed line L2, respectively, and the second filter group GB is composed of third plugs S3 and fourth plugs S4 supplied by the third feed line L3 and by the fourth feed line L4, respectively.

Below is a description of the conveying and combining system 6 according to the preferred embodiment.

A first roller 12 of the conveying and combining system 6 receives the first filter plugs S1′, supplied by the first feed line L1, in respective peripheral flutes 20.

The first roller 12 is rotationally driven by drive means (not illustrated) in a direction of rotation which in FIG. 2 is clockwise and denoted by the label W1.

The peripheral flutes 20 of the first roller 12 are arranged circumferentially, preferably spaced at equal angular intervals a from each other.

At the first roller 12 there is a cutting means 36 designed to divide the plugs S1′ along further cutting lines TT.

In this regard, it should be noted that this dividing operation might also be performed at an earlier stage, at one of the rollers downstream of the roller 7 in the first line L1 (for example in a manner very similar to or the same as those described with reference to the second line L2) or at the selfsame roller 7 by the same cutting means 8.

In FIG. 2, by way of a non-limiting example, each filter plug S1′ is divided into two plugs which are denoted individually by the label S1.

These plugs S1 constitute a component of the first filter group GA.

The first filter plugs S1 are thus conveyed by the first roller 12 and released to a second roller 13 forming part of the conveying and combining system 6 and acting in conjunction with the first roller 12.

The transfer of the first filter plugs S1 from the first roller 12 to the second roller 13 occurs in a region denoted R0 in FIG. 2.

The second roller 13 is rotationally driven by drive means (not illustrated) in a direction of rotation which in FIG. 2 is counterclockwise and denoted by the label W2.

At the second roller 13 the first filter plugs S1 are longitudinally spaced from each other.

In this case, too, it should be noted that if the filter plugs S1′ are divided to form the first filter plugs S1 in the first line L1, the operation by which the plugs S1 are longitudinally spaced might be performed at an earlier stage, at one of the rollers downstream of the cutting means 36 in the first line L1.

A third roller 14 of the conveying and combining system 6 receives the second filter plugs S2, supplied by the second feed line L2.

The third roller 14 is rotationally driven by drive means, which are not illustrated, in a direction of rotation W1.

The third roller 14 is furnished with peripheral flutes 22 which are arranged circumferentially, preferably spaced at equal angular intervals a from each other.

The transfer conveyor 11 of the second feed line L2 releases the second filter plugs S2 into the peripheral flutes 22 of the third roller 14 in a region R1, which is clearly visible in FIG. 3.

The third roller 14 acts in conjunction with the second roller 13.

In effect, in a transfer region R2, the second roller 13 releases the first filter plugs S1 into the peripheral flutes 22 of the third roller 14.

With reference to FIG. 3, it should be noted that downstream of the transfer region R2 relative to the conveying direction W1 of the third roller 14, each flute 22 of the third roller 14 holds a pair of first plugs S1 and a pair of second plugs S2, arranged in longitudinally alternate succession, as shown clearly in FIG. 3 in the circle above the third roller 14.

Thus, in more general terms, downstream of the transfer region R2 relative to the conveying direction W1, each flute 22 holds at least one first plug S1 and at least one second plug S2.

The combination of the first and second plugs S1 and S2 forms a first filter group GA.

It should also be noticed that in the example illustrated, each first filter group GA is formed by two first plugs S1 and two second plugs S2 arranged in longitudinally alternate succession. This must be considered purely by way of an example.

The third roller 14 releases the first filter groups GA to a fourth roller 15.

In effect, in a transfer region R3 where the plugs S1, S2 pass from the third roller 14 to the fourth roller 15, the third roller 14 releases the first filter groups GA into peripheral flutes 23 of the fourth roller 15.

The peripheral flutes 23 of the fourth roller 15 are preferably spaced at equal angular intervals a from each other.

Thus, each flute 23 of the fourth roller 15 accommodates a first filter group GA.

The fourth roller 15 is driven in rotation in a direction labeled W2 in such a way as to release the first filter groups GA to a fifth roller 16 in a transfer region R4.

The fifth roller 16 is driven in rotation in the direction W1.

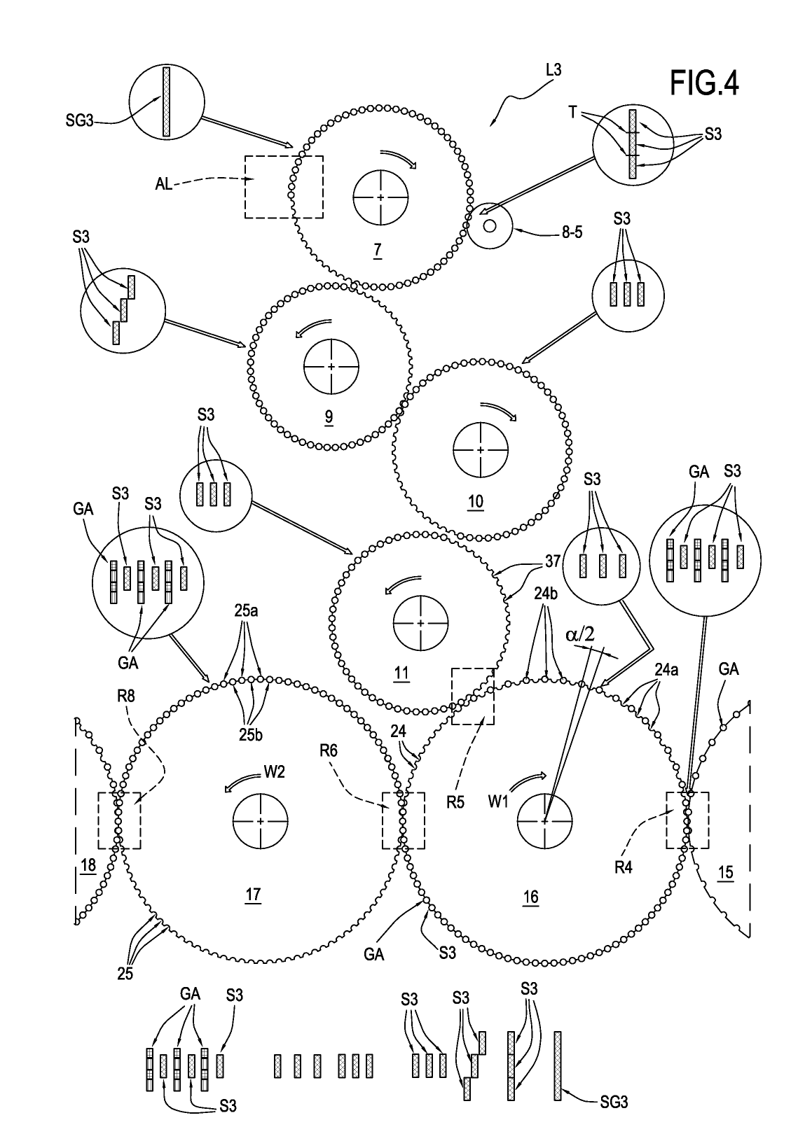

With reference to FIG. 4, it should be noted that the fifth roller 16 is furnished with peripheral flutes 24 which are equally spaced at angular intervals from each other by an angle that is equal to half of the angle α. More specifically, the fifth roller 16 comprises a first group 24a of flutes 24 designed to accommodate the first filter groups GA and a second group 24b of flutes 24 designed to accommodate the third plugs S3, that is to say, one of the components of the second filter group GB.

The flutes 24a of the first group and 24b of the second group of the fifth roller 16 are circumferentially arranged in alternate succession.

In light of this, it should be noted that in the example illustrated in FIG. 4, the flutes 24a, 24b of each group are spaced at angular intervals a from each other.

It should also be noted that in a third transfer region R5 of the third feed line L3, the transfer roller 11 places the third plugs S3 into the flutes 24b of the second group of flutes 24.

As illustrated in FIG. 4 by way of a non-limiting example, there is only one third plug S3 in each flute 37 of the transfer roller 11 of the third feed line L3.

With regard to the fifth roller 16, it should be noted that downstream of the transfer region R5 relative to the conveying direction W1, each flute 24b of the second group of flutes 24 holds a third plug S3 and each flute 24a of the first group of flutes 24 holds a first filter group GA.

In a transfer region R6, the fifth roller 16 releases the first filter groups GA and the third plugs S3 into the peripheral flutes 25 of a sixth roller 17.

The sixth roller 17, too, comprises peripheral flutes 25 which are circumferentially spaced from each other by an angle which is equal to a half of α.

The flutes 25 hold the first filter group GA or the third plug S3.

In effect, a first group of flutes 25, denoted by the label 25a, hold the first filter group GA and a second group of flutes 25, denoted by the label 25b, hold the third plug S3.

The sixth roller 17 is driven in rotation in the direction labeled W2.

Downstream of the sixth roller 17, the conveying and combining system 6 comprises a seventh roller 18.

The seventh roller 18 is driven in rotation in the direction W1.

The seventh roller 18 comprises peripheral flutes 26 which are circumferentially spaced from each other preferably by an angle which is equal to a half of α.

A first group 26a of the flutes 26 is designed to accommodate the first filter groups GA, while a second group 26b of the flutes 26 is designed to accommodate the plugs that will make up the second filter group GB, that is to say, the third and fourth plugs S3 and S4.

In a transfer region R7, the transfer roller 11 of the fourth feed line L4 releases the fourth plugs S4 into the flutes 26b of the second group of flutes.

The seventh roller 18 conveys the fourth plugs S4 into the flutes 26b and in a transfer region R8 alternately receives from the sixth roller 17 the first filter groups GA and the third plugs S3.

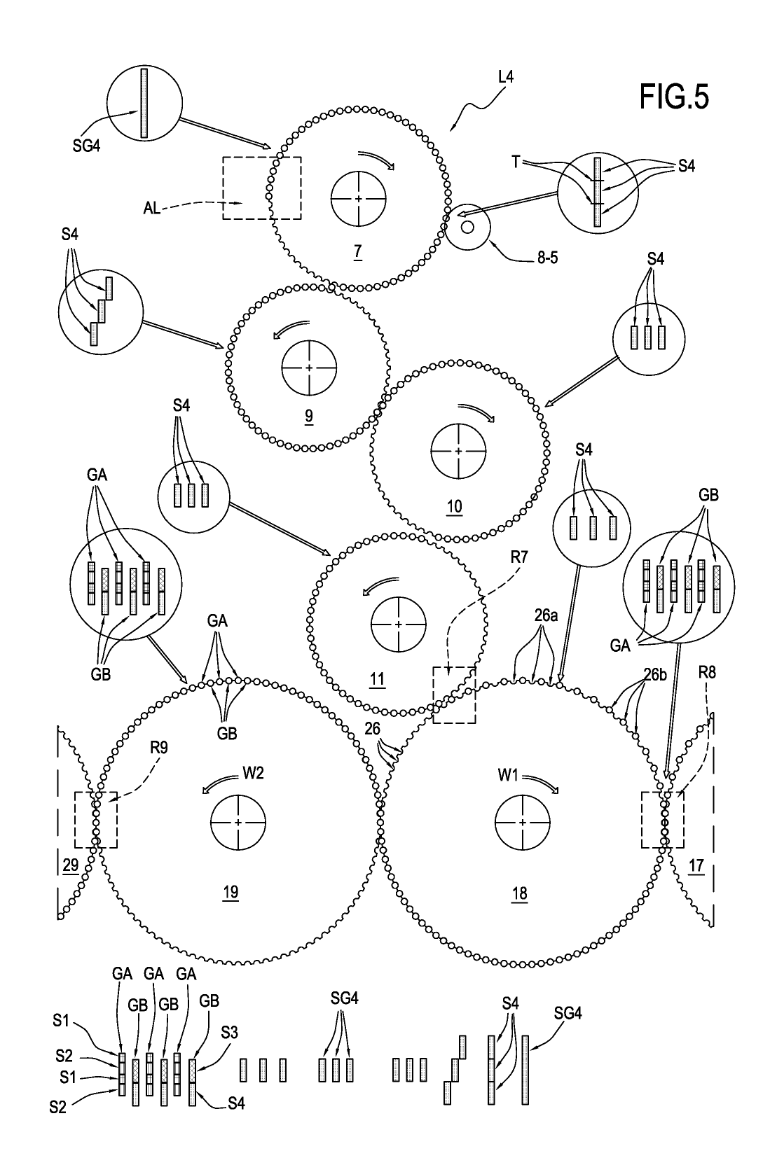

Downstream of the coupling region R8 relative to the conveying direction W1 of the plugs in the seventh roller 18, each flute 26b of the second group of flutes 26 holds a third plug S3 and a fourth plug S4, that is to say, a second filter group GB, and each flute 26a of the first group of flutes 26 holds a first filter group GA, as shown clearly in FIG. 5.

Thus, in the embodiment illustrated in FIGS. 1 to 6, the third plug S3 and the fourth plug S4 in each flute 26a form the second filter group GB.

In this embodiment, the seventh roller 18 is the outfeed roller of the conveying and combining system 6, that is to say, the last roller on the conveying path along which the filter plugs S1, S2, S3, S4 made from the different filter sticks SG1, SG2, SG3, SG4 are combined with each other.

The seventh roller 18 releases the filter groups GA, GB to a transfer unit 28 which passes the filter groups GA, GB received from the conveying and combining system 6 to a garniture tongue 2 (also forming part of the machine) which forms a continuous filter rod.

The transfer unit 28 is of the type described in patent EP1787534 which is incorporated herein by reference for completeness of description.

The garniture tongue 2, also of known type, comprises two parallel channels CA and CB for forming two filter rods BA, BB.

More specifically, again in the preferred embodiment, the transfer unit 28 comprises a first roller 19, acting in conjunction with the last roller 18 of the conveying and combining system 6.

The first roller 19 of the transfer unit 28 is furnished with respective peripheral flutes adapted to receive the first and second filter groups GA and GB alternately.

The transfer unit 28 also comprises a second roller 29, acting in conjunction with the first roller 19, to receive from the latter in a coupling region R9 the first and second filter groups GA and GB alternately.

A third roller 30, forming part of the transfer unit 28, acts in conjunction with the second roller 29 to take up from the latter only the first filter groups GA in a coupling region R10.

Downstream of the coupling region R10 where the second roller 29 meets the third roller 30, relative to the conveying direction of the filter groups GA, GB on the second roller 29, the second roller 29 transports only the second filter groups GB.

In a transfer region R11, the third roller 30 releases the filter groups GA to a fourth roller 31 also forming part of the unit 28.

A fifth roller 32, also forming part of the transfer unit 28, acts in conjunction with the second roller 29 to take up from the latter the second filter groups GB in a transfer region R12.

It should be noted that the fifth roller 32 and the fourth roller 31 are positioned to transfer a first filter group GA and a second filter group GB, respectively, in a region R13 substantially simultaneously.

A rotating member 27, of known type and for this reason illustrated schematically, takes up successions of one first filter group GA and one second filter group GB and transfers them to the garniture tongue 2 downstream, keeping them parallel to their longitudinal axes.

The rotating member 27 thus directs the filter groups GA, GB in such a way that they advance with their axes parallel to the direction of extension of the garniture channels CA, CB.

The garniture tongue 2 is designed to receive from the rotating member 27 of the transfer unit 28 the first and second filter groups GA, GB in the two channels CA, CB, respectively, in such a way as to form two different continuous filter rods BA, BB.

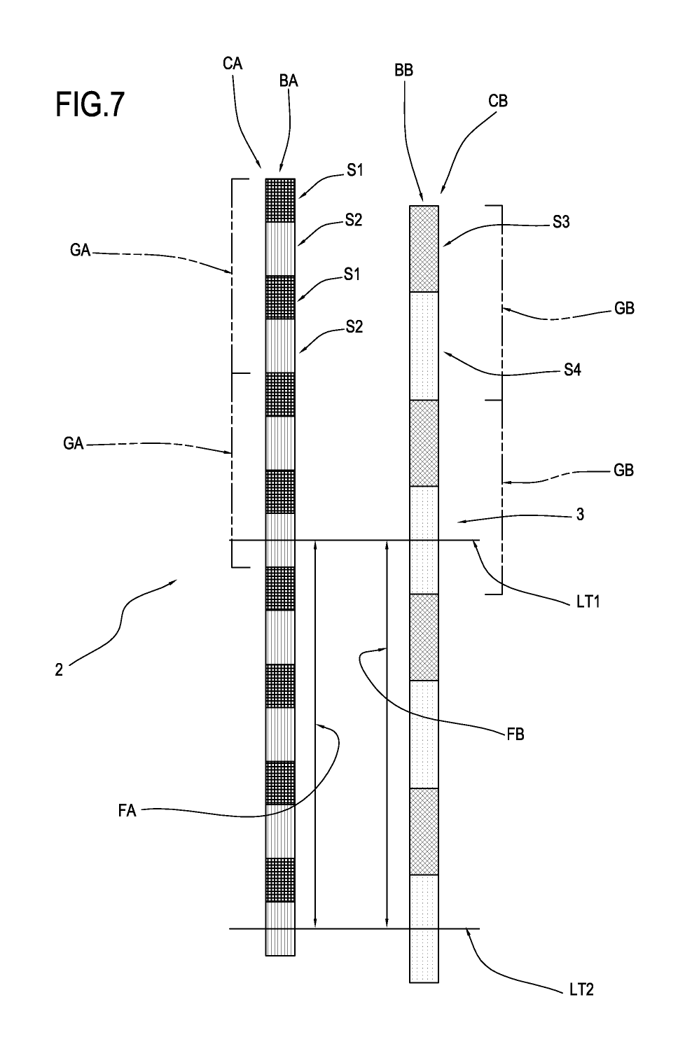

It should be noted, as illustrated in the scaled-up view of FIG. 7, that the first filter rod BA is made up of an ordered succession of first filter groups GA and the second filter rod BB is made up of an ordered succession of second filter groups GB. This advantageously makes it possible to obtain, at the outfeed end of the machine, successions of two filters FA, FB of different types, preferably used to make up cigarettes of different types or brands.

Downstream of the garniture tongue 2, the machine comprises a cutting means 3, of known type and illustrated schematically, by which both of the filter rods BA,BB are severed.

Preferably, the cutting means 3 severs both filter rods BA,BB simultaneously along a cutting line LT1.

In light of this, it should be noted that the filters FA, FB feeding out of the machine, that is to say, the filters FA, FB of the first and second channels CA and CB of the garniture tongue 2 all have the same longitudinal dimension, or length.

In FIG. 7, the reference label LT1 denotes the line where the cutting means severs the two filter rods BA and BB and the reference label LT2 a line where the cutting means previously severed them. The two lines LT1 and LT2 thus identify two respective filters FA and FB on the two channels.

In this regard, it should be noted that according to the invention the filters FA and FB are different, that is to say, they comprise filter plugs (whole or in portions) which differ from each other. That means, advantageously, that the machine 100 is capable of making two different types of cigarette filters simultaneously.

In light of this, in more general terms, that means each filter FA, FB is cut in such a way that each filter FA, FB comprises at least one top end portion, that is, forming the top end of the filter, and at least one bottom end portion, that is, forming the bottom of the filter.

Preferably, the filters are cut in such a way as to divide the bottom and top ends in half (for example, again with reference to FIG. 7, in the filter FA, the plug S1 is cut in half and in the filter FB, the plug S4 is cut in half).

In this description, the plug portions and/or plugs making up a filter FA, FB are denoted by the term “filter segments”.

In this regard, it should be noted, again with reference to FIG. 7, that the filter FA comprises nine filter segments (four whole plugs S1, three whole plugs S2 and two half-plugs S2, one at the top end and one at the bottom end), and the filter FB comprises five filter segments (two whole plugs S3, one whole plug S4 and two half-plugs S4, one at the top end and one at the bottom end).

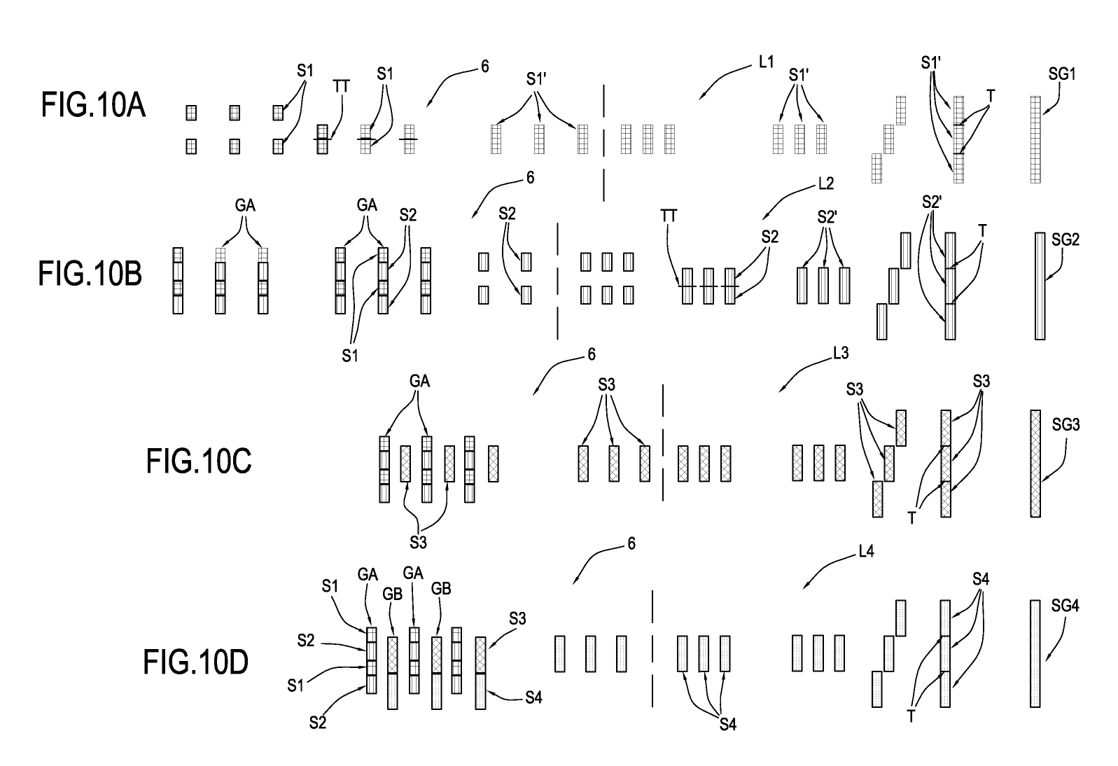

FIGS. 10A, 10B, 10C and 10D are scaled-up details from FIGS. 2 to 5, respectively, showing the sequence of dividing/conveying the sticks/plugs/filter groups in the machine 100. In this regard, it should be noted that FIGS. 10A, 10B, 10C and 10D, like FIGS. 2 to 5, show the sequence of feeding, dividing and combining one filter stick for each feed line L1, L2, L3, L4.

In other words, FIGS. 10A, 10B, 10C and 10D show the division of four filter sticks, namely, a first filter stick SG1, a second SG2, a third SG3 and a fourth SG4, and the path they follow within the machine 100.

Moreover, in this embodiment, the two filters FA and FB might also differ in diameter. In effect, the filter sticks SG1,SG2 making up the first filter group GA do not necessarily have to be the same in diameter as the filter sticks SG3,SG4 making up the second filter group GB.

The following are some considerations regarding alternative embodiments or variants of the machine 100, as well as some general considerations regarding the machine 100 itself.

In a variant not illustrated in the drawings, the plugs S1, S2, S3, S4 are combined in such a way that one of the two filter groups comprises filter plugs supplied by first feed lines, the other of the two filter group comprises filter plugs supplied by second feed lines (different from the first feed lines) and both filter groups further comprise at least one plug supplied by the same feed line.

In other words, according to this variant embodiment, one feed line supplies the conveying and combining system with plugs that are used to make up both the first and the second filter group, that is to say, both the first and the second filter rod.

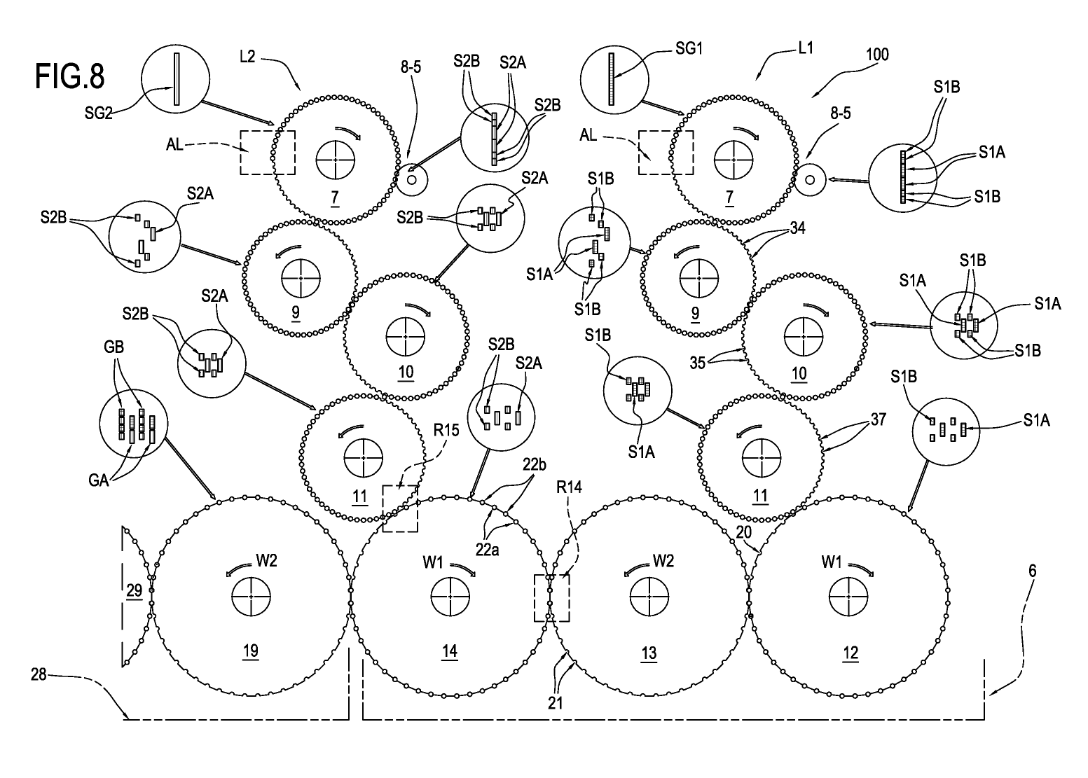

In an embodiment illustrated in FIG. 8, the machine 100 comprises a pair of feed lines L1, L2 designed to supply the conveying and combining system 6.

Preferably, the two feed lines L1, L2 are supplied, respectively, with filter sticks SG1, SG2 made of different materials and/or having different filtration properties, that is to say, with a first filter stick SG1 and a second filter stick SG2.

It should be noted that the feed lines L1, L2 preferably comprise the conveying rollers 7, 8, 9, 10 and 11 described above with reference to the preferred embodiment shown in FIGS. 1 to 6.

Each filter stick SG1, SG2 is divided, by the cutting means 8 described above, into two types of plugs differing in length and denoted respectively by the labels S1A (first type) and S1B (second type made from the first stick SG1 and S2A (first type) and S2B (second type) made from the second stick SG2.

It should be noted, with reference to the first feed line L1 illustrated in FIG. 8 (the second feed line L2 is substantially the same as the first feed line L1 and is not further described) that the roller 7 releases the plugs S1A and S1B to the intercalating roller 9 in such a way that the flutes 34 of the intercalating roller 9 hold plugs S1A of the first type and plugs S1B of the second type alternately.

According to this embodiment, the cutting means 8 severs the filter sticks asymmetrically in such a way as to make plugs of different lengths.

The centering roller 10 of the first feed line L1 longitudinally moves the plugs S1A of the first type and S1B of the second type.

More specifically, it should be noted that in the non-limiting example illustrated in FIG. 8, the flutes of the centering roller 10 alternately hold one plug S1A of the first type and two plugs S1B of the second type, spaced longitudinally from each other by a predetermined distance.

In this embodiment, the conveying and combining system 6 comprises three rollers (denoted by the reference labels 12 to 14).

The first feed line L1 releases alternately to the first roller 12 of the conveying and combining system 6 both the plugs S1A and the plugs S1B.

In exactly the same way as described with reference to the preferred embodiment, the first roller 12 releases the plugs S1A and S1B to the second roller 13.

The second roller 13 acts in conjunction with the third roller 14 and releases alternately the plugs S1A and S1B to the third roller 14 in a coupling region labeled R14.

Further, in a coupling region labeled R15, the second feed line L2 releases alternately to the third roller 14 the second plugs of the first type S1B and the second plugs of the second type S2B.

It should be noted that the third roller 14, in exactly the same way as that described with reference to the fifth roller 16 of the preferred embodiment, comprises a first group of flutes 22a designed to hold the components of the first filter group (that is, the plugs S1A and S2A) and a second group of flutes 22b designed to hold the components of the second filter group (that is, the plugs S1B and S2B).

In this embodiment, the first filter group GA is composed of the plugs S1A and S2A and the second filter group GB is composed of the plugs S1B and S2B.

The conveying and combining system 6 is configured to combine the plugs S1A with the plugs S2A and the plugs S1B with the plugs S2B along the path followed by the plugs.

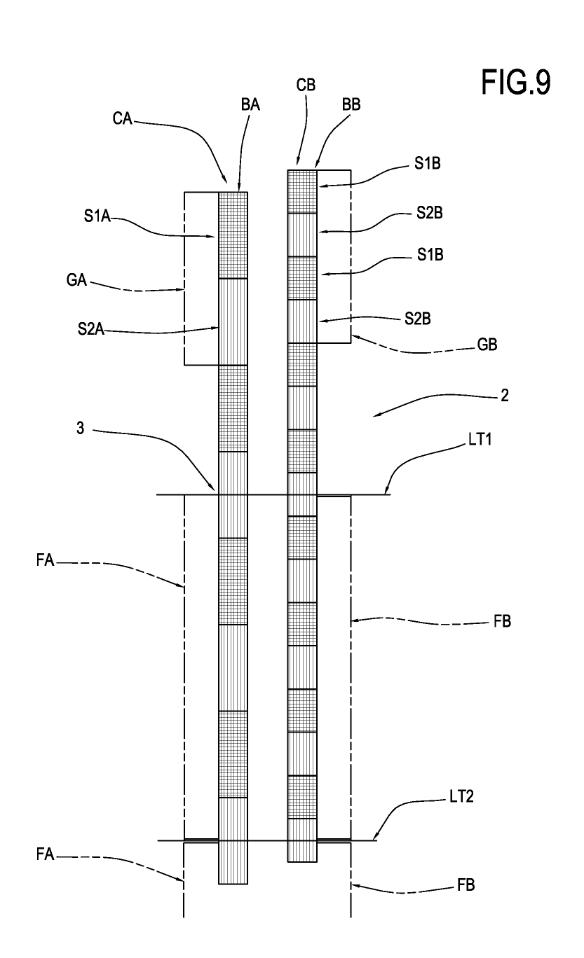

It should be noted that in this embodiment, as illustrated in FIG. 9, the two filter rods BA and BB, comprise plugs of the same type, or material (since both filter groups GA and GB are made from portions of the first and second filter sticks SG1 and SG2) but differing from each other in length.

With reference in particular to FIG. 9, which shows the two filter rods BA, BB made by the assembling machine 100 of FIG. 8, the first filter rod BA comprises filter plugs S1A and S2A in alternate succession, while the second filter rod BB comprises filter plugs S1B and S2B in alternate succession. By way of example, it should be noticed that the plugs S1A are longer than the plugs S1B, and in the same way, the plugs S2A are longer than the plugs S2B.

The following are some general considerations regarding the machine 100.

With reference to the feed lines L1, L2, L3, L4, it should be noted that the machine 100 comprises at least two feed lines.

It should also be noted, with reference to the conveying and combining system 6, that the machine 100 may comprise a larger or smaller number of rollers than those shown in FIGS. 1 to 6 or 8, depending on the selected operating configuration.

Preferably, moreover, the rollers of the conveying and combining system 6 are the same size and are driven at the same speed. This must not be considered as limiting the invention, since variants not illustrated might comprise rollers of different sizes, driven at speeds differing from each other and not necessarily constant during the course of one rotation cycle, and/or having differently spaced peripheral flutes on them.

Furthermore, the rollers of the conveying and combining system 6 might have any number of flutes on them and be proportionately sized and driven relative to each other in such a way as to convey and combine the filter groups as described above.

In much the same way, the considerations regarding the rollers of the conveying and combining system 6 also apply to the rollers of the feed lines.

To summarize and with reference to the above description, it should be noted that the machine 100 can substantially be configured to make three types of composite filter pairs FA, FB, made up as follows:

a) a first composite filter FA and a second composite filter FB comprising plugs of the same type, or material (preferably made from portions of the same sticks of filter material) but differing from each other in length, as illustrated in FIG. 9;

b) a first composite filter FA and a second composite filter FB comprising plugs of different types, or of different materials (preferably made from portions of the sticks of different types of filter material), as illustrated in FIG. 7;

c) a first composite filter FA and a second composite filter FB comprising some plugs of different types and some plugs of the same type or material.

In light of this, it should nevertheless be noted that the two filters FA and FB made by the machine 100 are in any case always the same in length, since both filter rods BB and BA are severed simultaneously by a single cut to make the filters FA, FB.

Advantageously, the machine 100 is a versatile machine that can be adapted with a few simple operating/design modifications to make a plurality of different composite filters.

In effect, the size of the filter sticks and the size of the plugs making up the filters can be modified according to a plurality of variants so the machine makes a plurality of different types of composite filters.

In light of this, it should be noted that the filter sticks supplied to the feed lines do not necessarily have to be the same size and may differ from each other in size.

The invention described above is susceptible of industrial application and may be modified and adapted in several ways without thereby departing from the scope of the inventive concept. Moreover, all the details of the invention may be substituted by technically equivalent elements.

What is claimed is:

1. A machine (100) for making composite filters (FA, FB), each consisting of at least two filter segments (S1, S2, S3, S4); the machine (100) comprising:
a plurality of feed lines (L1, L2, L3, L4) supplying filter plugs (S1, S2, S3, S4; S1A, S1B, S2A, S2B) made of different materials and/or having different filtration properties;
the machine (100) being characterized in that it comprises:
a conveying system (6) by which the plugs (S1, S2, S3, S4; S1A, S1B, S2A, S2B) are combined in such a way as to form and release a first succession and a second succession of filter groups (GA, GB) made of different materials and/or having different filtration properties, alternated one with another, each group (GA, GB) comprising a predetermined combination of filter plugs (S1, S2, S3, S4; S1A, S1B, S2A, S2B);
a garniture tongue (2) with two channels (CA, CB) along which a first filter rod (BA) and a second filter rod (BB) are formed, the first rod (BA) and the second rod (BB) respectively comprising the first succession and the second succession of filter groups (GA, GB);
cutting means (3) by which the two filter rods (BA, BB) are divided up to produce two respective successions of composite filters (FA, FB) differing one from another.

2. A machine as in claim 1, wherein the conveying and combining system (6) comprises a plurality of rollers (12, 13, 14, 15, 16, 17, 18) operating in conjunction one with another in such a manner as to transfer the plugs supplied by the feed lines (L1, L2, L3, L4) along a conveying path while forming the predetermined combination of plugs (S1, S2, S3, S4; S1A, S1B, S2A, S2B) along the selfsame conveying path.

3. A machine as in claim 2, wherein some of the rollers (12, 13, 14, 15) are designed to combine with each other the plugs (S1, S2) making up the first filter groups (GA), and the other rollers (16, 17, 18) are designed to combine with each other the plugs (S3, S4) making up the second filter groups (GB).

4. A machine as in claim 2, wherein the rollers (12, 13, 14, 15, 16, 17, 18) are furnished with respective peripheral flutes (20, 21, 22, 23, 24, 25, 26) serving to convey the plugs (S1, S2, S3, S4; S1A, S1B, S2A, S2B), and at least some rollers (16, 17, 18) of the plurality (12, 13, 14, 15, 16, 17, 18) are designed to convey plugs (S1, S2, S3, S4) making up different filter groups (GA, GB) in consecutive peripheral flutes (20, 21, 22, 23, 24, 25, 26).

5. A machine as in claim 4, wherein each roller (12, 13, 14, 15) is designed to convey plugs (S1, S2, S3, S4; S1A, S1B, S2A, S2B) making up different filter groups (GA, GB) in consecutive flutes.

6. A machine as in claim 1, wherein at least one line (L1, L2) of the plurality of feed lines (L1, L2, L3, L4) comprises:
feed means (AL) supplying sticks (SG1, SG2, SG3, SG4) of filter material;
cutter means (5) by which each stick (SG1, SG2, SG3, SG4) of filter material is severed along at least one transverse cutting line (T) so as to produce the single filter plugs (S1, S2, S3, S4);
means (9, 10, 11) by which the filter plugs (S1, S2, S3, S4) are conveyed.

7. A machine as in claim 6, wherein the cutter means (5) are configured in such a way as to divide each stick (SG1, SG2, SG3, SG4) of filter material into at least two plugs (S1A, S1B) of dissimilar length, of which one plug (S1A) of the two plugs (S1A, S1B) is destined to make up a filter group (GA) forming part of the first succession, and the other plug (S1B) of the two plugs (S1A, S1B) is destined to make up a filter group (GB) forming part of the second succession.

8. A machine as in claim 7, wherein the conveying means (9, 10, 11) are rotary components furnished with peripheral flutes (34, 35, 37) in which one plug (S1A) and the other plug (S1B) of the two plugs (S1A, S1B) are accommodated in alternating sequence.

9. A method of manufacturing composite filters (FA, FB) comprising two or more filter segments (S1, S2, S3, S4; S1A, S1B, S2A, S2B), including the step of:
supplying filter plugs (S1, S2, S3, S4; S1A, S1B, S2A, S2B) made of different material and/or having different filtration properties by means of a plurality of feed lines (L1, L2, L3, L4), the method being characterized in that it comprises the further steps of;
conveying and combining the filter plugs (S1, S2, S3, S4) supplied by the feed lines (L1, L2, L3, L4) in such a manner as to form a first succession and a second succession of filter groups (GA, GB) made of different materials and/or having different filtration properties, alternated one with another, each group (GA, GB) consisting of a predetermined combination of filter plugs (S1, S2);
wrapping the first succession and the second succession of filter groups (GA, GB) in respective strips (25) of paper material so as to create a first filter rod (BA) incorporating the first succession of filter groups (GA), and a second filter rod (BB) incorporating the second succession of filter groups (GB);
cutting the filter rods (BA, BB) in such a manner as to produce discrete composite filters (FA, FB) differing one from another.

10. A method as in claim 9, wherein the step of conveying and combining the filter plugs (S1, S2, S3, S4) comprises a step of transferring the plugs transversely to their axes in the flutes of rotating rollers (12, 13, 14, 15, 16, 17, 18) forming part of a conveying and combining system (6).

11. A method as in claim 9, wherein the step of supplying the filter plugs (S1, S2, S3, S4) made of different materials and/or having different filtration properties comprises the steps of:
preparing a succession of filter sticks (SG1, SG2, SG3, SG4) made of the selfsame different materials and/or having different filtration properties;
cutting the filter sticks (SG1, SG2, SG3, SG4) to produce the single plugs (S1, S2, S3, S4).

12. A method as in claim 11, wherein the filter sticks (SG1, SG2, SG3, SG4) are cut in such a manner as to obtain at least two plugs (S1A, S1B) of dissimilar length, of which one plug (S1A) makes up a filter group forming part of the first succession of such groups (GA), and the other plug (S1B) makes up a filter group forming part of the second succession of such groups (GB).

13. A method as in claim 9, wherein the conveying and combining step comprises the step of combining the plugs (S1, S2, S3, S4) in such a manner that one filter group (GA) of the two is composed of filter plugs (S1, S2) supplied by first feed lines (L1, L2), and the other filter group (GB) of the two is composed of filter plugs (S3, S4) supplied by second feed lines (L3, L4).

14. A method as in claim 9, wherein the conveying and combining step comprises the step of conveying and combining the filter plugs in such a manner that both of the two filter groups (GA, GB) comprise at least one plug of the same type and/or having the same filtration properties.
